(19) United States
(12) Patent Application Publication
(10) Pub. No.: US 2021/0388510 A1
(43) Pub. Date: Dec. 16, 2021

(54) SHORT MESSAGE SERVICE TRANSCEIVER MODULE

(71) Applicant: INA Acquisition Corp., Wilmington, DE (US)

(72) Inventors: George H. Hayes, Chiefland, FL (US); Clement A. Firlotte, Medina, OH (US)

(21) Appl. No.: 16/902,374

(22) Filed: Jun. 16, 2020

(51) Int. Cl. C23F 13/22; H04W 4/14; H04L 29/12; C23F 13/04

(52) U.S. Cl. CPC C23F 13/22; C23F 13/04; H04L 61/605; H04W 4/14

(57) ABSTRACT

A cathodic protection system comprising a short message system (SMS) transceiver. The SMS transceiver comprises a modem having a telephone number uniquely associated with it and a processor coupled to the modem. The processor is configured to retrieve sensor data from an input module of the cathodic protection system in response to an incoming SMS message from a remote telecommunication device when the incoming SMS message complies with a predetermined format. The processor is also configured to retrieve output voltage and current data from a rectifier monitor of the cathodic protection system in response to an incoming SMS message from the remote telecommunication device when the incoming SMS message complies with the predetermined format. The processor then sends the retrieved data to the remote telecommunication device via an outgoing SMS message.

### BACKGROUND

Users of impressed current cathodic protection (ICCP) need a reliable solution for remotely monitoring and controlling ICCP rectifiers and test stations. Conventional internet-based data acquisition and control systems require the use of a propriety server and data processing to set up remote operation. And even though electronic devices are available for monitoring and controlling ICCP and other pipeline/bridge/infrastructure systems, they do not provide remote operation via the internet or remote data logging functions.

Moreover, conventional monitoring solutions are costly to procure, implement, and operate and are not always available as add-ons to existing systems. This narrows the use of remote monitoring to the most important assets, such as rectifiers or test stations, in certain areas (e.g., High Consequence Areas (HCAs), or areas that are inaccessible).

### SUMMARY

Aspects of the present disclosure permit a user to quickly set up remote data acquisition and control systems using a short message service (SMS) server system in place at all cellular telephone providers. In addition, voltmeters, sensor transmitters and custom third-party electronic devices for cathodic protection measurement that have local area communication capability but lack remote internet control or communication capability can be quickly added to the SMS communications system. These devices will have the ability to be read and controlled using any text-enabled cellular device.

In an aspect, a cathodic protection system comprises a rectifier configured to apply a DC voltage to a structure to be protected, an input module configured to receive sensor data from one or more sensors associated with the cathodic protection system and a short message system (SMS) transceiver coupled to the input module. The SMS transceiver comprises a modem having a telephone number uniquely associated therewith and configured to send and receive SMS messages. The SMS transceiver is responsive to an incoming SMS message having a predetermined format to retrieve the sensor data from the input module. The incoming SMS message is sent from a remote telecommunication device to the telephone number uniquely associated with the modem. The SMS transceiver is further responsive to the incoming SMS message having the predetermined format to send the retrieved sensor data via an outgoing SMS message to the remote telecommunication device.

In another aspect, an SMS transceiver is for use with a cathodic protection system. The cathodic protection system comprises a rectifier configured to apply a DC voltage to a structure to be protected and an input module configured to receive sensor data from one or more sensors associated with the cathodic protection system. The SMS transceiver comprises a modem having a telephone number uniquely associated therewith that is configured to send and receive SMS messages. The SMS transceiver also comprises a processor coupled to the modem. The processor is configured to retrieve the sensor data from the input module in response to an incoming SMS message to the modem from a remote telecommunication device when the incoming SMS message complies with a predetermined format. The processor is further configured to send the retrieved sensor data to the remote telecommunication device via an outgoing SMS message from the modem.

In yet another aspect, a method remotely monitors a cathodic protection system. The cathodic protection system comprises a rectifier configured to apply a DC voltage to a structure to be protected, an input module configured to receive sensor data from one or more sensors associated with the cathodic protection system, and a rectifier monitor configured to measure one or more of an output voltage and an output current of the rectifier or control an operational parameter of the rectifier or both. The method comprises receiving, at a modem of an SMS transceiver coupled to the input module and the rectifier monitor, an incoming SMS message from a remote telecommunication device and determining if the incoming SMS message complies with a predetermined format. In response to the incoming SMS message complying with the predetermined format, the method includes retrieving at least one of the sensor data from the input module and the one or more of the output voltage and the output current and formatting an outgoing SMS message according to at least one of a human-readable format and a machine-readable format. The method further comprises sending, by the modem, the retrieved sensor data to the remote telecommunication device via the formatted outgoing SMS message.

Other objects and features will be in part apparent and in part pointed out hereinafter.

### BRIEF DESCRIPTION OF THE DRAWINGS

FIG. 1 illustrates a cathodic protection system including a short message system (SMS) transceiver according to an embodiment.

FIG. 2 is a block diagram of the SMS transceiver of FIG. 1.

FIG. 3 illustrates an example flow for operating the SMS transceiver of FIG. 1 in a command mode.

FIG. 4 illustrates an example flow for operating the SMS transceiver of FIG. 1 in a record mode.

FIG. 5 illustrates a cathodic protection system including an SMS transceiver according to another embodiment.

Corresponding reference characters indicate corresponding parts throughout the drawings.

### DETAILED DESCRIPTION

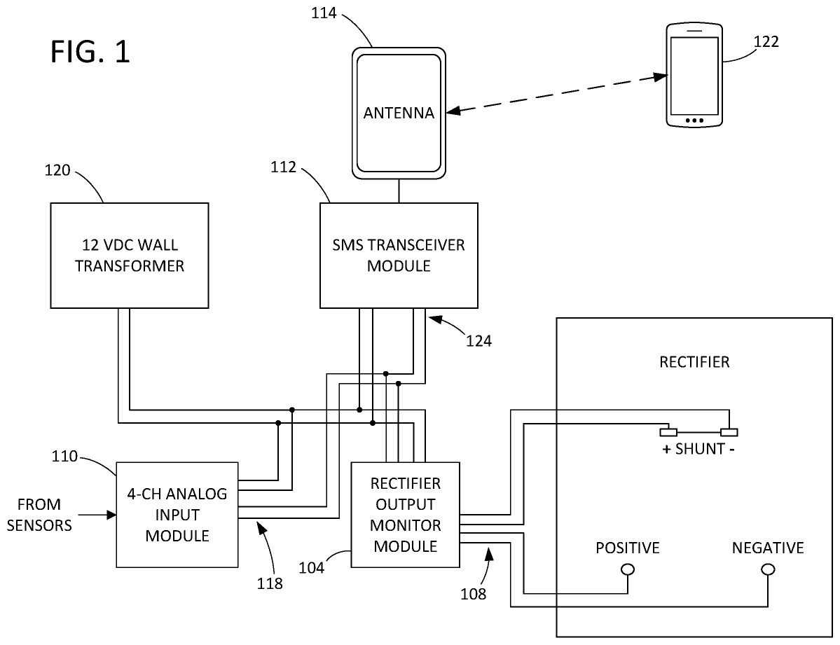

FIG. 1 illustrates a cathodic protection system embodying aspects of the present disclosure. The system includes a rectifier 102 (e.g., a high voltage rectifier module, an AC transformer type rectifier, etc.) configured to be electrically coupled to a structure to be protected. As shown, the rectifier 102 is electrically and communicatively coupled to a rectifier monitor 104 (e.g., a high voltage rectifier monitor module) via a sensor cable 108 (e.g., a four-conductor sensor cable). The illustrated configuration permits monitoring and transmitting data from rectifier 102. For example, monitor 104 measures and sends the output voltage and current of rectifier 102 at a preset interval. In an embodiment, the illustrated configuration also includes a sensor transmitter or input module 110 (e.g., a 4-channel or 8-channel analog input sensor transmitter module or data acquisition module) for receiving inputs from one or more sensors (not shown) and communicating the received sensor data via, for example, an output sensor bus 118. It is to be understood that the system of FIG. 1 includes either the monitor output module 104 or the input module 110 or both.

The input module 110 and/or monitor 104 are electrically and communicatively coupled to each other and to a short message system (SMS) transceiver module 112 embodying aspects of the present disclosure. For sending and receiving SMS messages (i.e., text messages), the SMS transceiver 112 includes a cellular antenna 114. A power source 120, such as 12 VDC 1500 mA Wall Transformer, provides electrical power to the various components of FIG. 1.

The rectifier monitor 104 enables monitoring and/or controlling rectifier 102 remotely (e.g., via a computing device and communication network, etc.). The rectifier 102 may be installed for use on pipelines, above-ground and/or below-ground storage tanks (e.g., tank farms, storage facilities, etc.), and any like structures (e.g., those at power generating plants, gas stations, off-shore drill rigs, etc.) that utilize impressed current cathodic protection (ICCP). The rectifier monitor 104 greatly reduces the time needed to maintain, monitor, and/or adjust rectifier 102. Furthermore, the enhanced reporting capabilities of the rectifier monitor 104 enables operators of rectifier 102 to meet governmental reporting regulations, for example, faster and more cost effectively than conventional techniques.

Referring further to FIG. 1, rectifier monitor 104 according to embodiments of the present disclosure comprises a high voltage rectifier output monitor that measures the voltage and current output of a high voltage rectifier, such as rectifier 102, used in pipelines, tank farms, other oil field applications, and the like, and transmits these measurements to a user. For instance, the high voltage rectifier output monitor 104 provides a DC output voltage for interruption of rectifiers equipped with an external interrupt input. The interrupt achieves GPS accuracy when used with the SMS transceiver 112. This output is also suitable for controlling an associated phase controller module and providing remote adjustment of TAP style rectifiers.

Aspects of the present disclosure permit a user to quickly and easily add remote readout and control of any compatible third party device using a remote telecommunication device (e.g., a text-enabled cellular device 122) as well as send the data to a management system, such as the Asset Integrity Management (AIM) platform available from Aegion.

The ICCP system of FIG. 1 utilizes inputs from a number of sensors, which are typically electro-mechanical devices that measure physical properties, including potential, temperature, pressure, etc. For example, a sensor mounted on a pipeline is configured to sense fluid pressure within the pipeline. In another example, a corrosion reference cell embedded in concrete or soil provides a potential measurement. In FIG. 1, input module 110 comprises a multi-channel input module coupled to the transceiver module 112. The input module 110 receives sensor inputs from a plurality of sensors and provides the sensor signals to the transceiver 112 for transmission to an external reporting and management service or the like.

Sensor transmitters provide a connection point for sensors, read and convert raw signals into a usable format, and then transmit the converted sensor data to another device, where the data may be displayed to the operator. The input module 110 in this embodiment is configured to store at least six months of sensor data and function as a sensor transmitter. In an embodiment, input module 110 comprises a 4-channel data acquisition module having four differential input channels for receiving readings from: an AgCl or CuSO corrosion half cell; a pipeline pressure sensor, a soil or air temperature sensor; and a soil or air wetness sensor. The module 110 in this embodiment consumes very little power and operation is possible with a small solar panel and/or battery.

When coupled with a data radio for transmitting the stored sensor data, input module 110 operates as a standalone sensor transmitter. For example, a 900 MHz long range data radio extends the reach of the two-wire communication network by acting as ‘invisible wires’ with a range of several kilometers. Any of the 900 MHz data radios that receives data from the two-wire communication network can immediately transmit the data over the airways. Any other 900 MHz data radio in range can receive this data and retransmit it over the two-wire communication network. The use of data radios permits multiple widely separated modules to use the same SMS transceiver 112 resulting in reduced data costs. All rectifiers 102 and monitor modules 104 in this embodiment that are connected to the same two wire communication network can perform GPS accurate instant off measurements.

In another embodiment, the multi-channel input module 110 comprises a general purpose voltage measurement device such as an 8-channel analog input sensor transmitter having eight fully differential inputs capable of measuring analog voltages up to +/−15 VDC is four ranges. The 8-channel module 110 is typically used for measuring low voltage rectifier outputs, CP half cell potentials, and any other analog output.

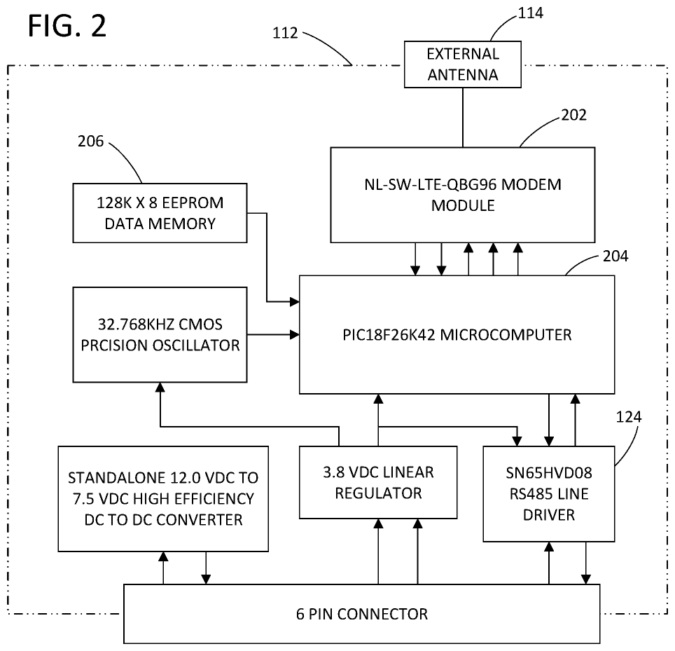

The SMS transceiver 112 includes a cellular modem 202 (see FIG. 2) having an associated unique telephone number. In operation, a user communicates with a remote ICCP system by sending specially formatted text messages to SMS transceiver 112 using the modem's telephone number. The messages each contain, for example, the transceiver module's name (or address) and a command plus any required parameters. The addressed or named SMS transceiver 112 then performs the action requested by the command, and sends back the results to the number of the cellular SMS device 122 that sent the message. Commands are specially formatted and the incoming text message must contain the exact text or SMS transceiver 112 will ignore the message. This acts as a password and eliminates responding to unwanted text messages. In other words, requiring knowledge of the modem telephone number and the specific command syntax to use the system provides security.

In an embodiment, transceiver 112 includes added functionality for email via, for example, Verizon's vtext.com to send and receive data from the modem 202. The modem 202 receives the same commands via SMS from the cellular carrier. Command response or timed logging data can be sent via email to the requesting email address, or another email address as specified by the user.

In another embodiment, transceiver 112 includes direct TCP/IP communications functions. In this mode, a TCP/IP socket connection is made with modem 202. Any data received by modem 202 via the TCP/IP connection is re-transmitted on the sensor data network and any data received by modem 202 over the sensor data network is sent to the TCP/IP connection. This permits a computer system or operator to take direct control of remote sensors and/or actuators via the sensor network. SMS control of the system is still available. The TCP/IP function in this embodiment is enabled/disabled via SMS command for additional security.

The SMS transceiver 112 is configured for communicating two types of response messages. The first is a human readable format, presenting the data received from input module 110 as a list of the sensor parameters. The second is a machine readable format, which compresses the data to maximize the amount of data in a single message. This is the format used to transmit the data to a repository and reporting system, such as Aegion's Asset Integrity Management platform. The SMS transceiver 112 can also retrieve sensor data from input module 110 at a preset interval and automatically send the data to a selected telephone number via a text message.

Appendix A provides examples of SMS message formats for sending data by SMS transceiver 112 embodying aspects of the present disclosure.

In addition, rectifier monitor 104 also sends the rectifier voltage and current values to the SMS transceiver 112 when requested. This feature allows older TAP set rectifiers to have features comparable to modern remotely-controlled rectifiers.

In an embodiment, SMS transceiver 112 permits text message control and logging of remotely-controller rectifiers (e.g., rectifier 102) and data acquisition systems modules (e.g., input module 110).

As shown in FIG. 2, SMS transceiver 112 comprises, for example, a Verizon CAT 1 SMS modem module 202, a processor such as microcomputer 204 with a two-wire RS485 sensor network connection 124, and a standard RS232 connection. The SMS transceiver 112 in this embodiment utilizes cellular antenna 114 and connection to the two-wire RS485 sensor bus 118. In addition, SMS transceiver 112 includes a nonvolatile memory 206.

The SMS transceiver 112 is configured to communicate with and control a wide variety of remote sensor modules. These include 4- and 8-channel, analog input data acquisition modules (e.g., input module 110), rectifiers (e.g., rectifier 102) and rectifier controllers (e.g., monitor 104), digital input/output, and more. These modules are capable of measuring potentials, temperatures, pressure, and taking readings from a number of other analog sensors. The SMS transceiver 112 is further configured to retrieve data from rectifier 102 in real time and remotely set the output voltage and current using any SMS text enabled device. The SMS transceiver 112 in this embodiment is capable of interfacing directly with many third party devices such as voltmeters and other instrumentation. Digital input/output modules allow monitoring and control of remote equipment such as pumps, gate opening notification, and remote control.

The SMS transceiver 112 is assigned a unique telephone number by the cellular carrier. In operation, the SMS transceiver 112 waits for a properly formatted command text message to be sent to the telephone number. When a text is received, SMS transceiver 112 examines the text message to determine if it contains a properly formatted command as described below. Unsolicited text messages are ignored. When a properly formatted command is received, SMS transceiver 112 attempts to contact the requested module over the network connection 124 to retrieve input data from input module 110 or change operational parameters of the rectifier 102 via monitor module 104.

In one embodiment, the SMS transceiver 112 has the following operating characteristics:

Input Voltage: 5-7.5 VDC Low Range; 9-14 VDC High Range

Input Current: Up to 3 AMPS Transmitting (1 AMP typical)

Cellular Carrier: Verizon

Antenna: Reverse SMA (2 required)

Module Comm: Corrpro Simple Sensor Network™

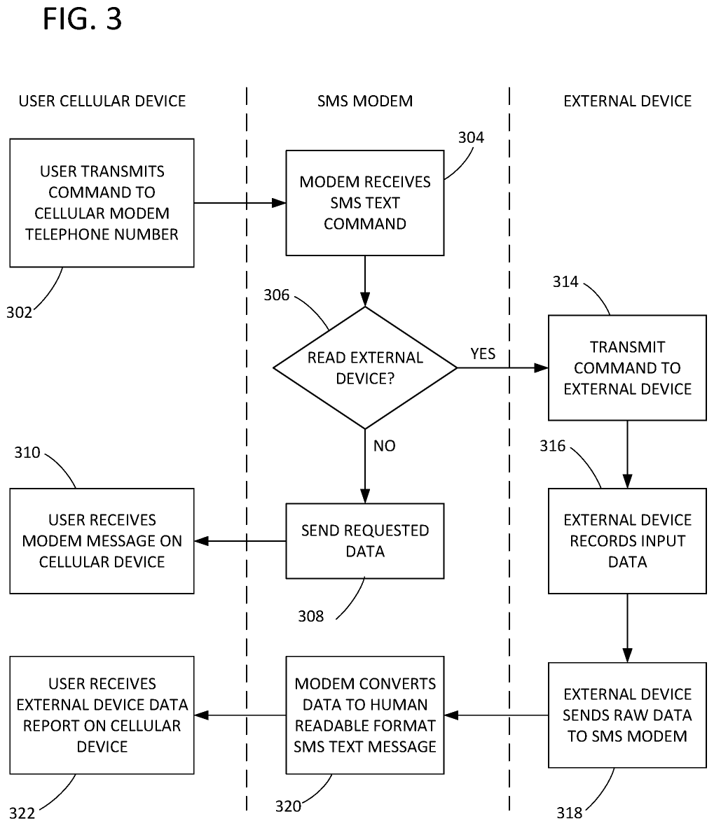

FIG. 3 illustrates an example flow for operating the SMS transceiver 112 in a command mode for retrieving input data or changing an operational parameter of the input module 110 and/or rectifier monitor module 104.

Beginning at 302, a user transmits a command to SMS transceiver 112 using the transceiver's assigned telephone number. At 304, SMS transceiver 112 receives the user's text message and then, at 306, determines if the requested data, for example, is available in memory 206. If so, the SMS transceiver 112 does not need to read the data from an external device, such as input module 110 or rectifier monitor 104. The SMS transceiver 112 retrieves the requested data from memory 206 and sends it at 308 to the user in an SMS message. In turn, the user receives the SMS message containing the requested data at 310 via his or her own cellular device 122.

On the other hand, if SMS transceiver 112 determines at 306 that it must read the requested data from the external device, it proceeds to 314 for transmitting a command for input data. At 316, the external device, such as input module 110 or rectifier monitor 104, records the input data and at 318 sends raw data to the SMS transceiver 112. In this example, SMS transceiver 112 converts the raw data to a human readable format at 320 as described above. At 322, the user receives the SMS message containing a report of the formatted data via his or her own cellular device 122.

Appendix B provides examples of SMS command message formats embodying aspects of the present disclosure.

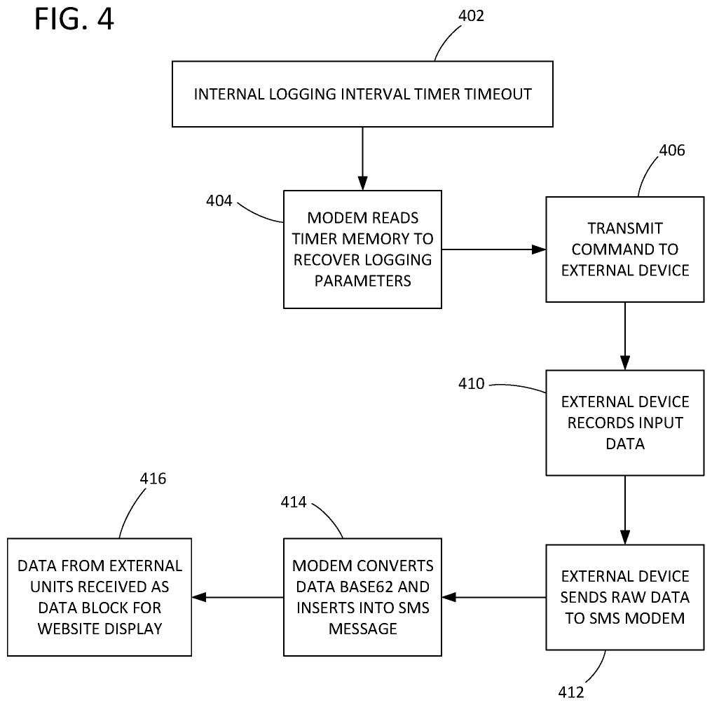

Referring to FIG. 4, SMS transceiver 112 is configured to executed timed data logging commands. The SMS transceiver 112 is configurable to automatically read selected input modules 110 and/or rectifier monitor modules 104 and transmit the modules' input data in the form of SMS text messages to a pre-selected telephone number of the remote telecommunication device 122 at pre-selected time intervals. In an embodiment, transceiver 112 executes 20 timers available for data logging. Each timer has an interval counter which decrements every hour. What happens when the interval counter reaches zero depends on the module type and data logging mode selected.

There are 20 data logging timers, referred to as TIMER 01-20, in this embodiment. Each timer stores an interval counter, the telephone number to which messages are to be sent, and multiple input module and/or monitor module identifiers, depending on the recording mode. FIG. 4 illustrates an example flow for a record mode to automatically read and log data from selected input modules 110 and/or rectifier monitor modules 104 after a predetermined interval timer times out. Beginning at 402, the microcomputer 204 of transceiver 112 times an internal logging interval timer.

Once the predetermined timer interval has expired, at 404, SMS transceiver 112 reads an internal timer memory in microcomputer 204 to recover logging parameters. The logging parameters specify, for example, the particular module (e.g., input module 110 or rectifier monitor 104) from which data is to be read, the interval for reading the data, and the number to which the data is to be sent. At 406, transceiver 112 transmits a command to the specified module. In response, the specified module records input data at 410 and sends the raw data to SMS transceiver 112 at 412. SMS text messages are limited to 160 characters per message. According to an embodiment, SMS transceiver 112 at 414 first converts the module data to fixed width, base 62 and then packs the converted into the message without separators. This maximizes the amount of information conveyed in a single message.

Each of the 20 timers described above can cause the SMS transceiver 112 to read the input data from one or more modules at an interval previously entered by the user. The module data is then used to create an SMS message in one of the formats described below. The SMS transceiver 112 then transmits this message at 416 to the telephone number previously entered into the timer memory by the user.

Data logging information is stored in the SMS transceiver 112 nonvolatile memory 206.

Timed data acquisition is available in one of two modes: recording multiple modules in a single message; and recording data from a single module over an extended period of time.

Regarding recording multiple modules in a single message, this mode reads data from multiple modules and creates a single message containing data from each module. A list of module ID#'s to include in the message is stored the timer memory. The number of modules that can be included in a single SMS message depends on the module type. The timer interval counter is decremented every hour. When the interval counter reaches zero, the SMS transceiver 112 reads each of the modules in the list, encodes the readings to base62, then creates an SMS message containing the encoded module data. This continues until the maximum number of modules allowed for the type is reached or an ID value of zero (0) is reached. The message is transmitted immediately. Once the message is transmitted, the timer interval reloads, and the cycle repeats. This is the default recording mode.

Regarding recording data from a single module over an extended period of time, this mode reads data from a single remote module at the selected interval, encodes the data base62, then stores the data in internal memory 206. The timer interval counter is decremented every hour, and when the interval reaches zero, data is added to the message in a format dependent on the module type. The number of data points the SMS message can contain varies with the type of module used. The message is transmitted when the message can hold no more input data. The buffer is cleared and timing begins again. This mode is activated by adding 1000 to the module type number and entering the result as the type number.

There are 20 possible recording timers for controlling logging operations. On initial power up, these timers are inactive and there are no logging operations active. Each timer has associated data logging information stored in 1 of 20 memory locations known as timer memory. Data logging is enabled and initiated by loading information into 1 or more of the timers. This information is entered by sending specially formatted commands to the SMS transceiver.

The following chart shows the 20 timers and their associated timer memory locations. Active timers have non-zero entries. Inactive timers are ignored.

TABLE I

| TIMER 1 | | TIMER 2 | | TIMER 3 . . . 19 | | TIMER 20 | |
|---|---|---|---|---|---|---|---|
| PHONE# | 3525551212 | PHONE# | 3525551212 | PHONE# | 00000000 | PHONE# | 00000000 |
| TYPE: | 1001 | TYPE: | 0008 | TYPE: | 00 | TYPE: | 00 |
| INTERVAL: | 2 HOURS | INTERVAL: | 12 HOURS | INTERVAL: | 0 HOURS | INTERVAL: | 0 HOURS |
| ID# 1: | 1AE155E8 | ID# 1: | A01 | ID# 1: | 00000000 | ID# 1: | 00000000 |
| ID# 2: | 00000000 | ID# 2: | A02 | ID# 2: | 00000000 | ID# 2: | 00000000 |
| ID# 3: | 00000000 | ID# 3: | A03 | ID# 3: | 00000000 | ID# 3: | 00000000 |
| ID# 4: | 00000000 | ID# 4: | A04 | ID# 4: | 00000000 | ID# 4: | 00000000 |
| ID# 5: | 00000000 | ID# 5: | A05 | ID# 5: | 00000000 | ID# 5: | 00000000 |
| . | 00 . . . | ID# 6: | A06 | . | 00 . . . | . | 00 . . . |
| . | | | | . | | . | |
| . | | | | . | | . | |
| . | 00 . . . | . | 00 . . . | . | 00 . . . | . | 00 . . . |
| . | | . | | . | | . | |
| . | | . | | . | | . | |
| ID# 12 | | ID# 12: | | ID# 12: | 00000000 | ID# 12: | 00000000 |

In the example of Table I, the modules listed in a single timer must be of the same type and of the type specified in the type parameter. Table I shows the timer memory data with two active timers.

TIMER 1 in this example times a two-hour interval for reading data from rectifier 1AE155E8. The SMS transceiver 112 measures and stores voltage and current output of rectifier 102 (type 01) via monitor 104 every two hours. A single message can hold 23 rectifier readings (voltage and current). After 46 hours (23×2), SMS transceiver 112 transmits a message to 3525551212 containing the rectifier output data recorded every two hours. A time stamp is stored showing the time of the first set of readings. A time stamp for subsequent readings can be calculated by adding the interval to the start time.

TIMER 2 in this example times a 12-hour interval for reading data from an 8-channel ADAM 4117 analog input module (i.e., input module 110). The SMS transceiver 112 measures units A01 to A04. A single SMS message can hold four modules of 8-channel data. After 12 hours, SMS transceiver 112 transmits a message to 3525551212 containing four each 8-channel module data. A time stamp is stored showing time and date.

In this example, TIMERS 3-20 are not used.

Appendix C provides examples of data logging command messages embodying aspects of the present disclosure.

Referring again to FIG. 4, the record mode flow is described in connection with a specific example of activating a data logging operation according to an embodiment of the present disclosure is shown. Beginning at 402, the user activates a TIMER via a cellular telephone number by entering module type (tttt) and interval (hh) using the %SETLOG:,nn,hh,tttt,phone#, COMMAND (nn=TIMER NUMBER 01-20) command format. The user may enter multiple module ID#'s into the timer memory using the %ADDMOD:,nn,pp,modID command. In this example, the modules listed in a single TIMER are of the same type.

At 404, SMS transceiver 112 receives the user's text message. When the interval (in hours) entered in to the timer memory is reached, the SMS transceiver 112 records and/or sends a data message as appropriate for the module type. The SMS transceiver 112 proceeds to 406 for transmitting a command for input data. At 410, the external device, such as input module 110 or rectifier monitor 104, records the input data and at 412 sends raw data to the SMS transceiver 112.

EXAMPLE: User wants to send data from ADAM module(s) 01,02,03,04 at 12-hour interval every day and rectifier module 1AE174EE hourly readings to phone number 3302894635.

STEP 1: User activates TIMER 1 by texting %SETLOG:,01,12,08,3302894635 to the telephone number associated with SMS transceiver 112.

STEP 2: User adds ADAM module 01 to TIMER 1 by sending a text message %ADDMOD:,01,01,A01 to the telephone number associated with SMS transceiver 112.

STEP 3: User adds ADAM module 02 to TIMER 1 by sending a text message %ADDMOD:,01,02,A02 to telephone number associated with SMS transceiver 112.

The rest of the ADAM modules are added using this technique:

STEP 1: User activates TIMER 2 by texting %SETLOG:,02,01,1001,3302894635 to the telephone number associated with SMS transceiver 112.

STEP 2: User adds CORRPRO RECTIFIER module 1AE174EE to TIMER 2 by sending a text message %ADDMOD:,02,01,1AE174EE to the telephone number associated with SMS transceiver 112.

STEP 3: User confirms TIMER parameters are properly set by sending the message %LOGSTAT:,01 to the telephone number associated with SMS transceiver 112.

The SMS transceiver 112 responds as follows:

MODEM#: 1F8E7D6C

TIMER#: 01

TYPE: 08

PH#: 3302894635

INTERVAL: 12

STEP 3a. User Confirms the module ID# for each TIMER by sending the message %LOGLIST:,01 to the telephone number associated with SMS transceiver 112. The SMS transceiver 112 responds as follows:

$$M 0 : A 01$$

$$A 02$$

$$A 03$$

$$⋮$$

$$M 12 : A 12$$

If an error is made in entering the parameters, the user simply overwrites the parameter or clears the entire timer memory using the %CLRLOG:,01 (in this case, TIMER 01 is cleared) command and enter the parameters again. In most cases the data is sent to a SMS message portal where it is collected into files and available to the user over the internet. The modem 202 and module ID numbers and telephone number uniquely identify the module location and connection when correlated with installer data.

Below is a summary of text commands for use with SMS transceiver 112 embodying aspects of the present disclosure:

?PRADM:,nn,nn,nn,nn,nn; SEND ADAM DATA AS FORMATTED TEXT

?PRMOD:,nnnnnnnn,,,,nnnnnnnn; SEND MODULE DATA nnnnnnnn AS TEXT

STRING

?PRMET:,aa; SEND WEATHER STATION DATA

%SETVOLT:,nnnnnnnn:,max_volts:; SET RECTIFIER MODULE OUTPUT VOLTAGE

LIMIT

%SETAMP:,nnnnnnnn:,max_amps:; SET RECTIFIER MODULE OUTPUT

AMPERAGE LIMIT

%SETOUTP:,nnnnnnnn:,on/off; INTERRUPTS THE RECTIFIER OUTPUT

%SETLOG:,nn,hh,ttt,phone#; SET LOGGING PARAMETERS

%ADDMOD:,nn,pp,modID; ADD MODULE modID TO TIMERnN

%CLRLOG:,nn; CLEAR TIMER MEMORY LOCATION N

%LOGSTAT:,nn; SEND MESSAGE SHOWING STATUS OF TIMER MEMORY

%LOGLIST:,nn; SEND MESSAGE SHOWING TIMER nn MODULE LIST

%SNDMSG,<ph#>,<message>; SEND SMS MESSAGE TO PHONE

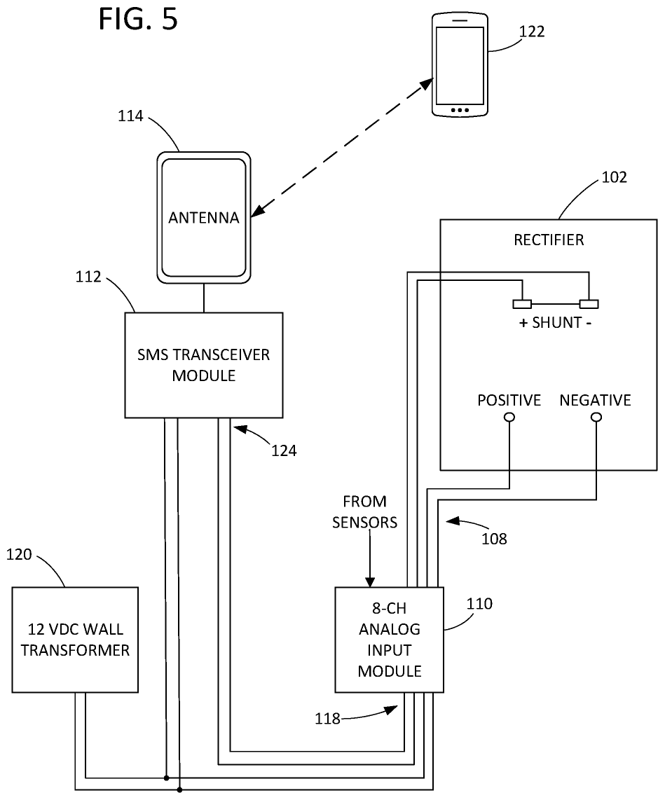

FIG. 5 illustrates an ICCP system according to an alternative embodiment. As shown, the rectifier 102 (e.g., low voltage rectifier with read shunt and output voltage) is electrically and communicatively coupled to the sensor transmitter or input module 110 (e.g., 8-channel analog sensor transmitter) for receiving inputs from one or more sensors (not shown) and communicating the received sensor data via, for example, the output sensor bus 118. The input module 110 is electrically and communicatively coupled to the SMS transceiver module 112. For sending and receiving SMS messages (i.e., text messages), the SMS transceiver 112 includes the cellular antenna 114. The power source 120 provides electrical power to the various components of FIG. 5.

The ability to transmit data to the end user is a critical part of the remote data acquisition process. In an embodiment, sensor transmitter modules 110, rectifier monitor modules 104, and the like are configured for communication using a two wire communication network. The modules 110 and/or 104 have two terminals in this embodiment for connecting communication wiring. The installer connects the modules 110 and/or 104 together in a ‘daisy chain’ manner with the wires looping from one module to the next. Modules can be separated by inches or hundreds of feet. In one embodiment, up to 32 modules 110 and/or 104 can be supported by a single two wire cable. A suitable communication network is the Corrpro Simple Sensor Network™ (CSSN) available from Corrpro Corporation, which is a two wire, half duplex, low speed RS485 two wire communications network. The modules connect to the same two communications wires and the network allows any module to transmit data and the other modules on the network to receive the data.

In an embodiment, one module 110 and/or 104 transmits at a time. To prevent multiple units transmitting at the same time, the network uses a master/slave topology. In this type of network, none of the modules transmit data until it receives a command to do so. Each module 110 and/or 104 contains a unique name, or address, built in to the module electronics.

Each network installation contains a single ‘master’ unit (i.e., transceiver 112) that sends commands to the different modules 110 and/or 104 connected to the network. There are two types of master units available: the SMS transceiver 112 and a mobile interrogation unit used by the installer on site to test and set up the modules 110 and/or 104.

Aspects of the present disclosure are suited for use with various types of rectifiers. In one embodiment, rectifier 102 comprises a high efficiency DC to DC rectifier module available from Corrpro Corporation. The rectifier 102 uses, for instance, switch-mode technology to provide a precise constant voltage or constant current DC output for medium and low power ICCP. The user sets the constant voltage and constant current output limits via remote control or external switches. The DC to DC converter output will remain at a constant voltage or constant current depending on the resistance of the CP circuit. The DC to DC rectifier module 102 of this embodiment requires a DC input voltage, the value of which depends on the module type and desired voltage level of the output. The high efficiency of DC to DC converter modules make them ideal for solar or other alternative power sources.

The rectifier module 102 has built in circuitry for measuring and transmitting the module's output voltage and current, eliminating the need for external data logging equipment.

In another embodiment, rectifier 102 comprises a low power DC to DC converter module that provides up to, for example, 6 volts @ 10 amps for ICCP applications. Such a rectifier is suited for concrete reinforcement bar applications. High conversion efficiency also makes this module suited for solar powered applications.

In yet another embodiment, rectifier 102 comprises a medium power DC to DC converter module that provides up to 36 volts @ 20 amps (250 W) for ICCP applications.

The modem module 202 includes built-in global positioning system (GPS) and I/O functions according to an embodiment. The GPS functions include, for example, location on demand, GPS timing for rectifier interrupt, and ‘trigger on location.’ The ‘trigger on location’ function triggers the system to record data or interrogate a specific module when a location is reached, or when the transceiver 112 has moved a predetermined amount away from its last recorded location. One of the main uses for this function will be to allow ‘Close Interval Surveys’ of pipelines where the location and data from a survey crew can be transmitted to a management system, such as AIM (or another receiver of SMS data) and recorded and/or plotted in real time as the survey progresses. Another use for this system would be in aircraft, drone, or other vehicle-type of pipeline survey, where the modem 202 is located in the aircraft/drone/vehicle and interrogates specific ground stations (rectifiers and CP test stations) equipped with data radios, that are known to be within the range of the aircraft/vehicle. Data from the remote stations would be recorded in memory 206 for later processing, or re-transmitted in real time via SMS to AIM or other processing system for real time presentation and/or plotting. Advantageously, pipeline engineers are able to monitor the survey in progress, and identify and re-examine problem areas while the crew is still on-site.

The GPS functionality also provides precise timing information that can be used to precisely synchronize interruption of rectifiers over a very wide area (e.g., (worldwide) for pipeline surveys and testing. This function is used in conjunction with rectifier controller/monitor modules, data radios and Data Acquisition Modules.

In another embodiment, transceiver 112 includes analog input channels (e.g., two), digital input channels (e.g., two), and a relay (e.g., single-pole double-throw) that are all under SMS control. Advantageously, transceiver 112 provides stand-alone functionality for applications such as monitoring of gates or other security applications where a user is notified by SMS message when a threshold is crossed or gate/door is opened. In this embodiment, transceiver 112 is configured for monitoring of temperatures, or other data alarms, and notifying personnel via SMS messages. Lights, motors, or other electrical equipment can be monitored and/or controlled via SMS messages using built-in I/O. Real time notification to select SMS users of changes in input status of the built-in sensors or of remote modules in general is contemplated. It is to be understood that certain functionality may require additional security such as password protection.

The order of execution or performance of the operations in embodiments illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of aspects of the disclosure.

When introducing elements of aspects of the disclosure or the embodiments thereof, the articles “a”, “an”, “the” and “said” are intended to mean that there are one or more of the elements. The terms “comprising”, “including”, and “having” are intended to be inclusive and mean that there may be additional elements other than the listed elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

### APPENDIX A

The following is an example data format:

Data from the remote modules 110 and/or 104 can be sent in one of two SMS message formats, one is for human reading of data and parameters, the other is for machine-to-machine (M2M) communications for presentation on a web site. This section provides information on the M2M data formats.

SMS messages are limited to 160 characters per message. All M2M messages begin with a 16-character header. The header is as follows

XXXXXmmmnndddttt

where:

XXXXX=5 character, base62, Modem ID#

mmm=3 character, module TYPE number (base62 more in following sections)

nn=2 character interval value (hours)

ddd=base 62 DATE

ttt=base62 TIME

The header includes all of the information needed to properly identify the data message for web site use.

The modem ID# identifies the site or location where the unit is installed. The modem ID# is encoded as five base62 characters. To properly display and use the modem ID#, first convert from base62 to decimal. The decimal number is then converted to an 8-character Hexadecimal format.

nn is the timing interval in HOURS 2 digit DECIMAL

The TYPE number indicates the type of module that sent the data. Type numbers are base62 and identified as follows (after converting to decimal):

If TYPE>1000 THEN message is single module

ELSE Message is group of modules as described below

If TYPE % 1000>100 message represents INSTANT OFF potentials

The three module types below use a fixed decimal point as follows: 999.99 (two decimal places) for voltage and current output.

01=Low Power DC to DC Converter

02=High Power DC to DC Converter

03=TAP Rectifier Controller

The 04 module type uses fixed decimal point as follows: 99.999 (three decimal places).

04=4 Channel CORRPRO DAS

The Type 104 module is the same module except readings are taken with rectifier OFF (interrupted).

The 08 module type uses fixed decimal point as follows: 99.999 (three decimal places). This module uses 3-character A0n as ID# where n=1−F. ID# NOT base62 encoded.

08=8 Channel ADAM

M2M messages from remote modules have two formats. Format is indicated by

TYPE number.

If TYPE is <1000 then the message has data from multiple modules in the same message as follows:
(header 16 bytes)(module_ID#)(Single module readings)(module_ID#](Single module readings)(module_ID#) (Single module readings)(module_ID#)(Single module readings) . . . . (module_ID#)(Single module readings)

The date and time in the header is the time the readings were taken for all modules.

The if TYPE is <1000 then the message has data from a single module over time as follows:
(header 16 bytes)(module_ID#)(Single module readings)(Single module readings) . . . (Single module readings)

The Time and Date numbers in the header indicate the time and date of the first reading in a multiple timed format. Date and Time for subsequent readings are found by adding the value in the Interval parameter to the stored time and date, one time interval for every additional reading. The module number is given only one time, immediately following the header in timed format messages.

The SMS message can hold a fixed number of readings. Each module has a different number of input channels so the total amount of readings over time is partially dependent on the module type. A reading consists of all of the available channels in a given module.

| | # INPUT | READINGS/ | READINGS/ | |
|---|---|---|---|---|
| | CHANNELS | MESSAGE | MESSAGE | |
| MODULE | PER | SINGLE | MULTIPLE | |
| TYPE | READING | MODULE | MODULE | RESOLUTION |
| 01, 02, 03 | 2 | 23 | 13 | 2 nnn.nn |
| 04 | 4 | 12 | 8 | 3 nn.nnn |
| 08 | 8 | 5 | 5 | 3 nn.nnn |

When logger TYPE parameter is <1000 multiple modules can send their data in 1 message. A message containing recent data from all modules in the list will be received at the number of hours in the INTERVAL parameter.

When the TYPE parameter is >1000 (1000+module type) the message holds a number of readings depending on the module TYPE. A set of readings is recorded at the INTERVAL number of hours. When the maximum number of readings for the module type (see above) is reached, a message is sent containing the module data. The frequency of the messages being sent is a function of the INTERVAL value and module type. For example, if the interval is set to 1 hour, a message from a rectifier module will be received every 23 hours. A message from the 4-channel data acquisition systems (DAS) module will be received every 12 hours and a message from the 8 channels DAS will be received every 5 hours.

TYPE NUMBER NOMENCLATURE

4-Digit Type Number is Defined as Follows:

0001

Where

First 0 is Record Mode (0=Multiple; 1=Single)

Second 0 is Instant OFF (0=ON; 1=OFF)

01 is Module Type (See Above)

Note: 1st two digit leading zero can be omitted if both=0 (Multiple|ON)

Base 62 encoding:

M2M SMS messages use base 62 encoding to maximize the amount of data carried in a single SMS text message. Base 62 encoding uses the characters 0-1, A-Z, a-z.

Module numeric data is first converted to a fixed width 5-digit decimal integer. The resolution of the voltage data from the modules depends on the type of module (see chart page 8). If the voltage data is negative, 100,000 is added to the value. The resulting number is then converted to 3-character base 62 before being inserted into the SMS message.

Corrpro Module ID#'s consist of 32 bit long integer usually expressed as an 8 character HEXADECIMAL number. Module ID numbers are first converted to decimal and then to a 5-character base 62 number. ID numbers are always positive. NOTE: Adam module addresses are always expressed as a 2-digit HEXADECIMAL format.

| MODULE TYPE | DATA RANGE | POSITIVE (B62) | NEGATIVE (B62) |
|---|---|---|---|
| 4/8 CH DAS module | 0-+/−99.999 | 0-99999 | 100001-199999 |
| | | (0-Q0t) | (Q0v-q1n) |
| All rectifier types | 0-+999.99 | 0-99999 | n/a |
| | | (0-Q0t) | |
| Corrpro addresses | 10000000-369B13DF | n/a | n/a |
| | (IAKK8-zzzzz) | | |
| ADAM addresses | 01-FF | n/a | n/a |
| | (HEXADECIMAL) | | |

All module data in a single message is assumed to be from the module type specified in the header. 10000000 (Q0u)=−0 NOT ALLOWED

```
    SAMPLE DATA BLOCK: SMS TEXT Data Block transmitted from from 4 ADAM
modules A01-A04.
    { UL3VZ 008 0C Aam 0a9 } [ A01 0lW 00B Q90 0Yw 006 Q8P 0nN 00B] [A02 QCD 0zz
    00B Q7R 0pA 00B Q2C 0hU] [A03 006 Q86 0n6 00B Qbu 0v0 00B QDV] [A04 10e 00B
    Qez 0lj 00A QA1 000 000] [A05 000 000 000 000 000 000 000 000 ]
    16 Character Header: {
```

| | |
|---|---|
| UL3VZ = 1AB8A4E9 | Modem ID for Site Identification |

```
    008 = 008 TYPE NUMBER Multiple Module Message ON values TYPE = 8 CH ADAM
    0C = 12  INTERVAL COUNTER IN HOURS
    Aam = 40720  DATE STRING 04/07/2020 (Leading zero omitted)
    0a9 = 2241TIME STRING 22:41 HOURS OR 10:41 PM
    }
    Data Block FOR 1ST ADAM [
    A01 ADDRESS STRING FOR 1ST ADAM
```

| | |
|---|---|
| 0lW = 2946 = 2.946V | VOLTAGE ON CHANNEL 1 |
| 00B = 0011 = 0.011V | VOLTAGE ON CHANNEL 2 |
| Q90 = 3233 = 3.233 | VOLTAGE ON CHANNEL 3 |
| 0Yw = 2166 = 2.166V | VOLTAGE ON CHANNEL 4 |
| 006 = 0006 = 0.006V | VOLTAGE ON CHANNEL 5 |
| Q8P = 100465 = −0.465 | VOLTAGE ON CHANNEL 6 > 100000 means negative |
| number | |
| 0nN = 3061 = 3.061V | VOLTAGE ON CHANNEL 7 |
| 00B = 0011 = 0.011V | VOLTAGE ON CHANNEL 8 |
| ] | |
| A02 000 ... ... A05 | |

The above sequence is repeated for the remaining 4 ADAM units A02-A04.

000000000=9 characters padding to fill out 160 character message.

### APPENDIX B

The following is an example print module data command for reading data from up to four rectifiers 102 and/or DAS modules:

?PRMOD:,nnnnnnnn,nnnnnnnn,nnnnnnnn,nnnnnnnn

nnnnnnnn=8 digit MODULE ID#

In response, the SMS transceiver receives the information from the rectifier 102 and/or DAS module 110 and sends a reply SMS message to the telephone number that sent the command. The SMS Message contains input data from the up to four modules specified in the command. The response message format depends on module type as shown below:

Rectifier Modules Type 01, 02, 03:

| DESCRIPTION | NAME | VALUE |
|---|---|---|
| ID# of modem module | MODEM# | 1A2B3C4D |
| ID# of rectifier module | MODULE# | 1A2B3C4D |
| Date of readings | DATE | MM/DD/YY |
| Time of readings | TIME | HH:MM |
| Voltage of rectifier output | VOLTS | +123.45 |
| Amperage of rectifier output | AMPS | +123.45 |
| Constant voltage limit | SETV | +123.45 |
| Constant current limit | SETA | +123.45 |
| Output interrupt status (on/off) | STATUS | ON |

DAS Module Type 04

| DESCRIPTION | NAME | VALUE |
|---|---|---|
| ID# of modem module | MODEM# | 1A2B3C4D |
| ID# of 4-channel module | MODULE# | 1BB17E2C |
| Date of readings | DATE | MM/DD/YY |
| Time of readings | TIME | HH:MM |
| Channel 1 reading | CH1 | −12.345 |
| Channel 2 reading | CH2 | −12.345 |
| Channel 3 reading | CH3 | −12.345 |
| Channel 4 reading | CH4 | −12.345 |
| Output interrupt status (on/off) | STATUS: | ON |

Each rectifier 102 has formatted return message. The format above applies to DC to DC switch-mode rectifier modules, TAP rectifier controllers, High Voltage/Amperage Rectifier Monitors, and Corrpro 4 Channel Analog Input Module.

The following are example commands for setting rectifier constant voltage limits, constant amperage limits, and output interrupt status (i.e., turn the rectifier on and off), respectively:

%SETVOLT:,nnnnnnnn:,max_volts

%SETAMP:,nnnnnnnn:,max_amps

%SETINT:,nnnnnnnn/ALL,ON/OFF

Regarding the rectifier output interrupt status, the command turns rectifier nnnnnnnn output ON or OFF and ‘ALL’ sets the output of all connected rectifiers.

The following is an example print module data command for reading data from up to four 8-channel analog input modules 110, such as an ADAM 4117 analog input module available from Advantech Co., Ltd.:

?PRADM:,a1,a2,a3,a4

a1-a4=2 character ADAM ID # 01-FF HEX

In response, the SMS transceiver receives the information from the analog input module and sends a reply SMS message to the telephone number that sent the command. The SMS message in this example contains eight channels of voltage input data from the up to four analog input modules specified in the command. The response message format is shown below:

| DESCRIPTION | NAME | VALUE |
|---|---|---|
| Modem ID# | MODEM# | 1A2B3C4D |
| Input Module ID# | ADAM# | 01 |
| Date of measurements] | DATE | MM/DD/YY |
| Time of measurements | TIME | HH:MM |
| Channel 1 input value | CH1 | +12.345 |
| Channel 2 input value | CH2 | +12.345 |
| Channel 3 input value | CH3 | +12.345 |
| Channel 4 input value | CH4 | +12.345 |
| Channel 5 input value | CH5 | +12.345 |
| Channel 6 input value | CH5 | +12.345 |
| Channel 7 input value | CH7 | +12.345 |
| Channel 8 input value | CH8 | +12.345 |

In this example, a separate reply SMS text message is sent for each module specified in the command.

The following is an example test modem status command for showing the status of the modem 202 and signal strength:

%MDMTST:,01

The SMS response from the modem 202 has the format shown below:

| | | |
|---|---|---|
| DESCRIPTION | NAME | VALUE |

MODEM TEST

| | | |
|---|---|---|
| Modem ID# | MODEM# | 12345678 |
| Date of test] | DATE | MM/DD/YY |
| Time of test | TIME | HH:MM |

+--SIGNAL--+

| | | |
|---|---|---|
| Signal strength | STRENGTH | ss |
| Channel bit error | BIT ERR | ee |
| rate (in percent) | | |

This command is used to test modem and cellular signal strength. Signal strength and bit error parameters are as used in the AT+CSQ command for the NL-SW-LTE-QBG96 modem 202. For instance, signal STRENGTH parameter ss=

| 0 | −113 dBm or less | |
|---|---|---|
| 1 | −111 | dBm |
| 2 . . . 30 | −109 . . . −53 | dBm |

| | |
|---|---|
| 31 | −51 dBm or greater |
| 99 | Not known or not detectable |

The following is an example print weather station data command for showing weather conditions from a weather station module:

?PRMET:,aa

aa=Weather Station ID#01-09

In response, the SMS transceiver receives the information from the weather module and sends a reply SMS message containing weather station data to the telephone number that sent the command.

The following is an example send SMS text message command for sending a text message from the modem 202:

%SNDMSG:,<ph#>,<message>

Sends text message <message> to phone number <ph#>. Recipient receives text from the modem phone number.

### APPENDIX C

The following are example data logging command messages.

Activate a logging timer, enter phone # and logging interval to activate a TIMER and sets logging parameters:

%SETLOG:,nn,hh,ttt,phone#

nn=TIMER NUMBER TO ACTIVATE (1-20)

hh=2 DIGIT HOUR TIME INTERVAL FOR LOGGING

tttt=4 digit module TYPE

phone#=PHONE NUMBER TO SEND MESSAGE (THIS MESSAGE ONLY)

Add modules to timer memory to set the module ID's for logging. The number of module ID's entered depends on the module type and recording mode.

%ADDMOD:,nn,pp,modID

nn=TIMER NUMBER TO ADD MODULE

pp=Position (1-12)

modID=MODULE ID# TO ADD TO TIMER (CORRPRO OR ADAM)

Clear (Deactivate) Timer:

%CLRLOG:,nn

nn=TIMER NUMBER TO CLEAR

[RESPONSE] Module DELETES all TIMER nn logging parameters.

Show Status of Logging Timers:

%LOGSTAT:,nn

nn=TIMER #

[RESPONSE] Module Sends messages showing status of TIMER nn as follows:

MODEM#: 1F8E7D6C

TIMER#: 01

TYPE: 08

PH#: 3302894635

INTERVAL: 12

Show Timer Module List:

$$\% LOGLIST : , nn$$

$$nn = RECORD TIMER \# \\ [ RESPONSE ] Module shows list of modules in TIMER MEMORY ( Module Address Below FOR EXAMPLE ONLY )$$

$$M 1 : 1 AE 1293 F$$

$$M 2 : 1 B 1 C 7747$$

$$⋮$$

$$M 12 : 1 BB 12 EC 2$$

What is claimed is:

1. A cathodic protection system comprising:
a rectifier configured to apply a DC voltage to a structure to be protected;
an input module configured to receive sensor data from one or more sensors associated with the cathodic protection system; and
a short message system (SMS) transceiver coupled to the input module, the SMS transceiver comprising a modem having a telephone number uniquely associated therewith and configured to send and receive SMS messages, the SMS transceiver responsive to an incoming SMS message having a predetermined format to retrieve the sensor data from the input module, the incoming SMS message sent from a remote telecommunication device to the telephone number uniquely associated with the modem, and SMS transceiver further responsive to the incoming SMS message having the predetermined format to send the retrieved sensor data via an outgoing SMS message to the remote telecommunication device.

2. The cathodic protection system of claim 1, further comprising a rectifier monitor coupled to the rectifier and the SMS transceiver, the rectifier monitor configured to measure one or more of an output voltage and an output current of the rectifier or control an operational parameter of the rectifier or both.

3. The cathodic protection system of claim 2, wherein the SMS transceiver is responsive to the incoming SMS message having the predetermined format to retrieve the one or more of the output voltage and the output current from the rectifier monitor and to send the retrieved one or more of the output voltage and the output current via the outgoing SMS message to the remote telecommunication device.

4. The cathodic protection system of claim 2, wherein the rectifier monitor is responsive to the incoming SMS message having the predetermined format received by the SMS transceiver to control the operational parameter of the rectifier via the rectifier monitor.

5. The cathodic protection system of claim 4, wherein operational parameter comprises an interrupt state and wherein the rectifier monitor is responsive to the incoming SMS message having the predetermined format received by the SMS transceiver to provide a DC output voltage to interrupt the rectifier.

6. The cathodic protection system of claim 2, wherein the predetermined format comprises an identifier of the modem of the SMS transceiver and at least one of an identifier of the input module and an identifier of the rectifier monitor.

7. The cathodic protection system of claim 1, wherein the SMS transceiver comprises a processor executing a timer and wherein the SMS transceiver is responsive to the timer expiring to retrieve the sensor data from the input module and to send the retrieved sensor data via the outgoing SMS message to the remote telecommunication device.

8. The cathodic protection system of claim 1, further comprising a cellular antenna coupled to the SMS transceiver.

9. The cathodic protection system of claim 1, wherein the input module is configured to accumulate and store the sensor data over a plurality of months.

10. The cathodic protection system of claim 1, wherein the SMS transceiver ignores the incoming SMS message when the incoming SMS message does not comply with the predetermined format.

11. The cathodic protection system of claim 1, wherein the sensor data in the outgoing SMS message comprises at least one of a human-readable format and a machine-readable format.

12. A short message system (SMS) transceiver for use with a cathodic protection system, the cathodic protection system comprising a rectifier configured to apply a DC voltage to a structure to be protected and an input module configured to receive sensor data from one or more sensors associated with the cathodic protection system, the SMS transceiver comprising:
a modem having a telephone number uniquely associated therewith, the modem configured to send and receive SMS messages; and
a processor coupled to the modem, the processor configured to retrieve the sensor data from the input module in response to an incoming SMS message to the modem from a remote telecommunication device when the incoming SMS message complies with a predetermined format, the processor further configured to send the retrieved sensor data to the remote telecommunication device via an outgoing SMS message from the modem.

13. The SMS transceiver of claim 12, wherein the processor is configured to retrieve one or more of an output voltage and an output current from a rectifier monitor of the cathodic protection system in response to the incoming SMS message to the modem from the remote telecommunication device when the incoming SMS message complies with the predetermined format, and wherein the processor is further configured to send the retrieved one or more of the output voltage and the output current to the remote telecommunication device via the outgoing SMS message from the modem.

14. The SMS transceiver of claim 13, wherein the processor is further configured to command the rectifier monitor to control an operational parameter of the rectifier in response to the incoming SMS message to the modem from the remote telecommunication device when the incoming SMS message complies with the predetermined format.

15. The SMS transceiver of claim 13, wherein the predetermined format comprises an identifier of the modem and at least one of an identifier of the input module and an identifier of the rectifier monitor.

16. The SMS transceiver of claim 12, wherein the processor is configured to execute a timer and is responsive to the timer expiring to retrieve the sensor data from the input module and to send the retrieved sensor data via the outgoing SMS message from the modem to the remote telecommunication device.

17. The SMS transceiver of claim 12, further comprising a cellular antenna.

18. The SMS transceiver of claim 12, wherein the processor ignores the incoming SMS message when the incoming SMS message does not comply with the predetermined format.

19. The SMS transceiver of claim 12, wherein the sensor data in the outgoing SMS message comprises at least one of a human-readable format and a machine-readable format.

20. A method of remotely monitoring a cathodic protection system, the cathodic protection system comprising a rectifier configured to apply a DC voltage to a structure to be protected, an input module configured to receive sensor data from one or more sensors associated with the cathodic protection system, and a rectifier monitor configured to measure one or more of an output voltage and an output current of the rectifier, the method comprising:
receiving, at a modem of a short message system (SMS) transceiver coupled to the input module and the rectifier monitor, an incoming SMS message from a remote telecommunication device;
determining if the incoming SMS message complies with a predetermined format;
in response to the incoming SMS message complying with the predetermined format, retrieving at least one of the sensor data from the input module and the one or more of the output voltage and the output current;
formatting an outgoing SMS message according to at least one of a human-readable format and a machine-readable format; and
sending, by the modem, the retrieved sensor data to the remote telecommunication device via the formatted outgoing SMS message.
